(19) United States
(12) Patent Application Publication
(10) Pub. No.: US 2020/0138156 A1
(43) Pub. Date: May 7, 2020

(54) MOBILE PHONE WALLET AND SYSTEM

(71) Applicant: Tiana Smith, Indianapolis, IN (US)

(72) Inventor: Tiana Smith, Indianapolis, IN (US)

(21) Appl. No.: 16/675,619

(22) Filed: Nov. 6, 2019

Related U.S. Application Data
(60) Provisional application No. 62/756,216, filed on Nov. 6, 2018.

(51) Int. Cl. A45C 11/00; A45C 1/06; H04B 1/3888

(52) U.S. Cl. CPC A45C 11/00; A45C 2011/002; H04B 1/3888; A45C 1/06

(57) ABSTRACT

A mobile phone wallet includes a mobile phone portion and a wallet portion. The wallet portion includes a first section and a second section, and a hinge pivotally coupling the first and second portions. Each of the first and second sections includes an inside surface structured to function as a traditional wallet. Wallet portion also includes a locking mechanism structured to secure the wallet. The locking mechanism is communicatively coupled to the mobile phone, which may include software configured to control the locking mechanism.

### TECHNICAL FIELD

The present disclosure relates generally to mobile phones.

### BACKGROUND

Mobile phones have joined wallets as indispensable accessories in modern society from which people are rarely separated in the course of their daily lives. The loss or theft of either may be more than a minor inconvenience as well, as each may contain sensitive information and/or valuables that, if recovered by a bad actor, may result in the loss of irreplaceable photographs, documents, and other sentimental or important documents or information, and may further cause the owner to suffer embarrassment, financial anguish, and/or other negative consequences. As hacking and other forms of digital crime have risen, so to have efforts to protect people's digital photos, documents, and personal information—for example, biometric authentication, encryption, and identity theft protection services. Even further, recovery of lost or stolen devices containing such information has been facilitated by technologies such as GPS. In contrast however, solutions for securing traditional, tangible photographs, documents, and other sensitive information important enough for owners to carry with them at all times has seen little advancement, leaving individuals vulnerable. As such, strategies for preventing unauthorized individuals from accessing a wallet, and for enhancing the chance of recovering a lost or stolen wallet remain desirable.

### SUMMARY OF THE INVENTION

In one aspect, device includes a mobile phone portion having a mobile phone, a wallet portion having a first section and a second section, with each of the first section and the second section having an inside surface, a hinge pivotally coupling the first section to the second section, and a lock assembly communicatively coupled to the mobile phone and structured to lock the device.

In another aspect, a system includes a security device having a mobile phone portion and a wallet portion, the wallet portion including a locking mechanism communicatively coupled to the mobile phone portion, and software configured to provide a user interface for controlling the locking mechanism. The mobile phone portion includes a processor structured to receive data from the software and a controller structured to receive a signal from the processor.

### BRIEF DESCRIPTION OF THE DRAWINGS

FIG. 1 is a perspective view of a mobile phone wallet in a locked configuration, according to one embodiment;

FIG. 2 is a diagrammatic first side view of a mobile phone wallet in a locked configuration, according to one embodiment;

FIG. 3 is a diagrammatic second side view of a mobile phone wallet in a locked configuration, according to one embodiment;

FIG. 4 is a diagrammatic bottom view of a mobile phone wallet, according to one embodiment;

FIG. 5 is a partially cross-sectioned side view of a locking mechanism for a mobile phone wallet in a resting position, according to one embodiment;

FIG. 6 is a partially cross-sectioned side view of a locking mechanism for a mobile phone wallet in an activated position, according to one embodiment;

FIG. 7 is a diagrammatic view of a mobile phone wallet in an open configuration, according to one embodiment;

FIG. 8 is a block diagram of a mobile phone wallet system, according to one embodiment; and

FIG. 9 is a flowchart of a software algorithm for a mobile phone wallet.

### DETAILED DESCRIPTION

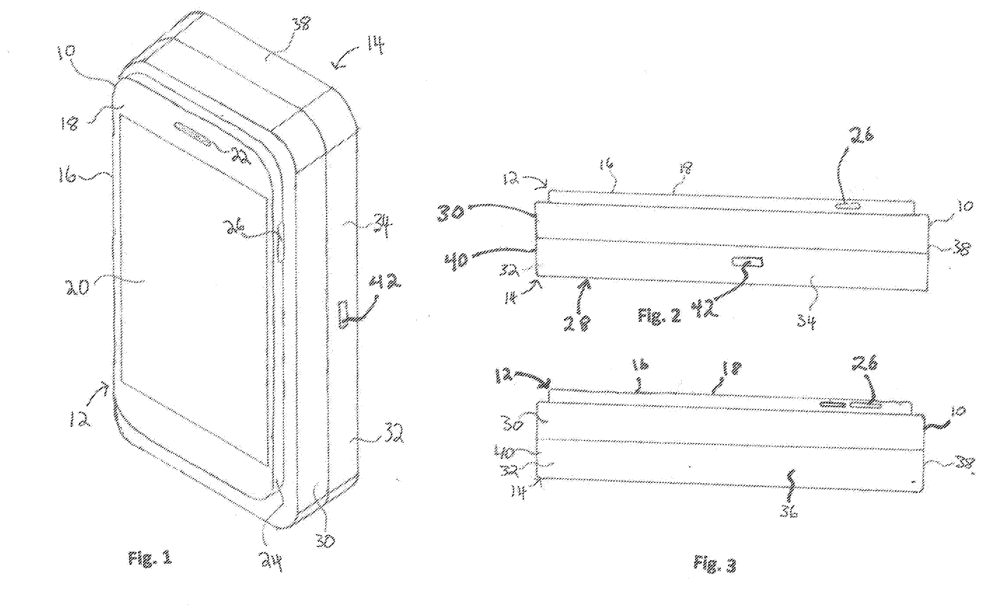

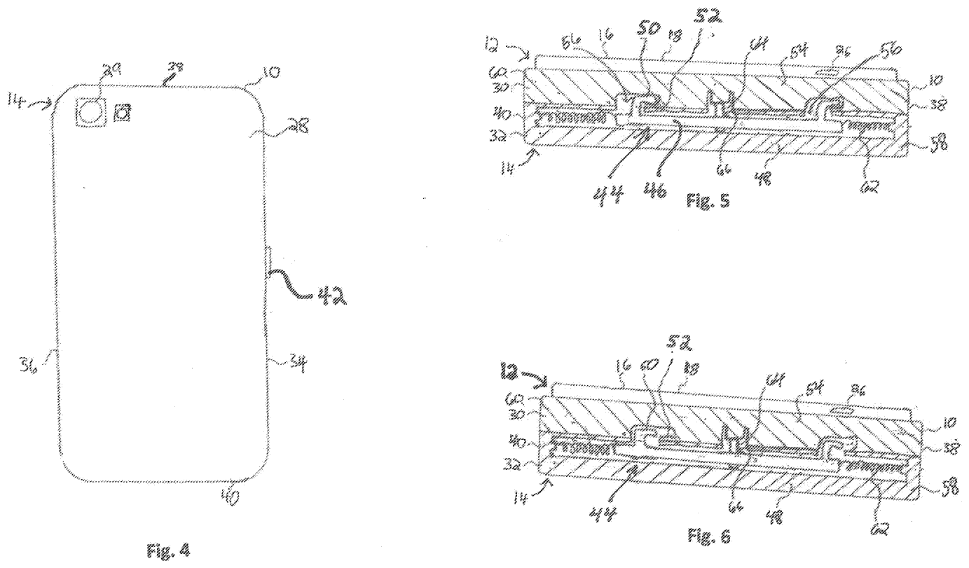

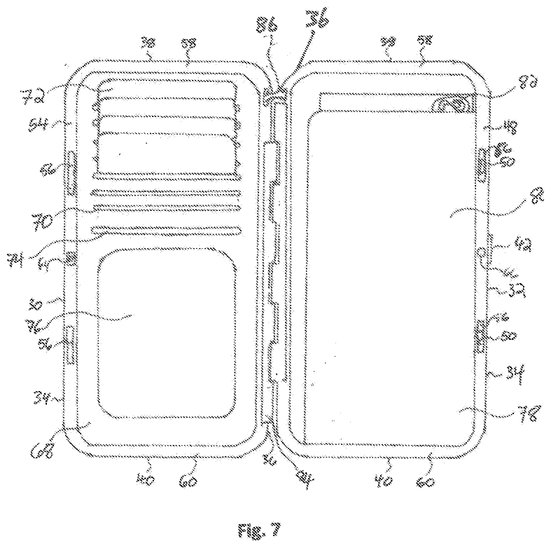

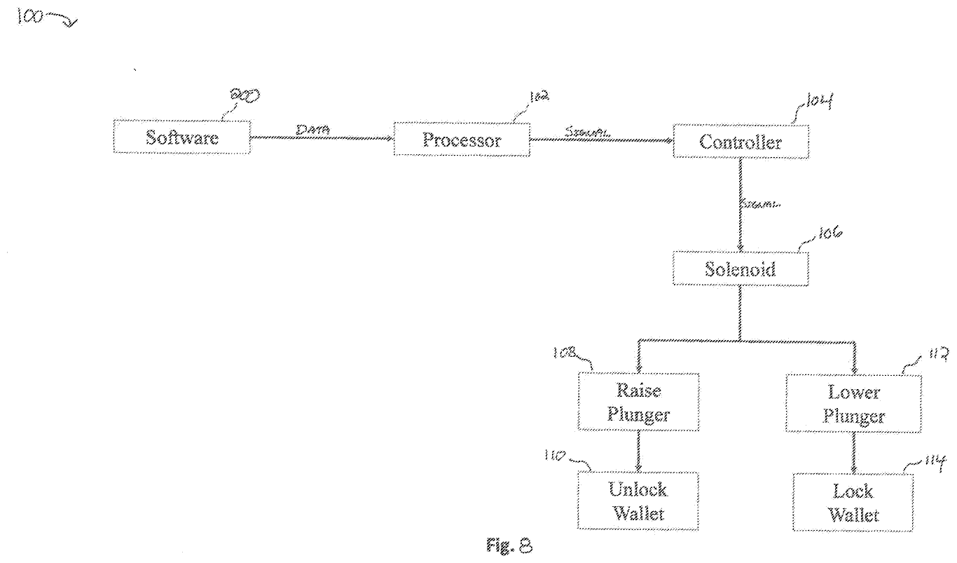

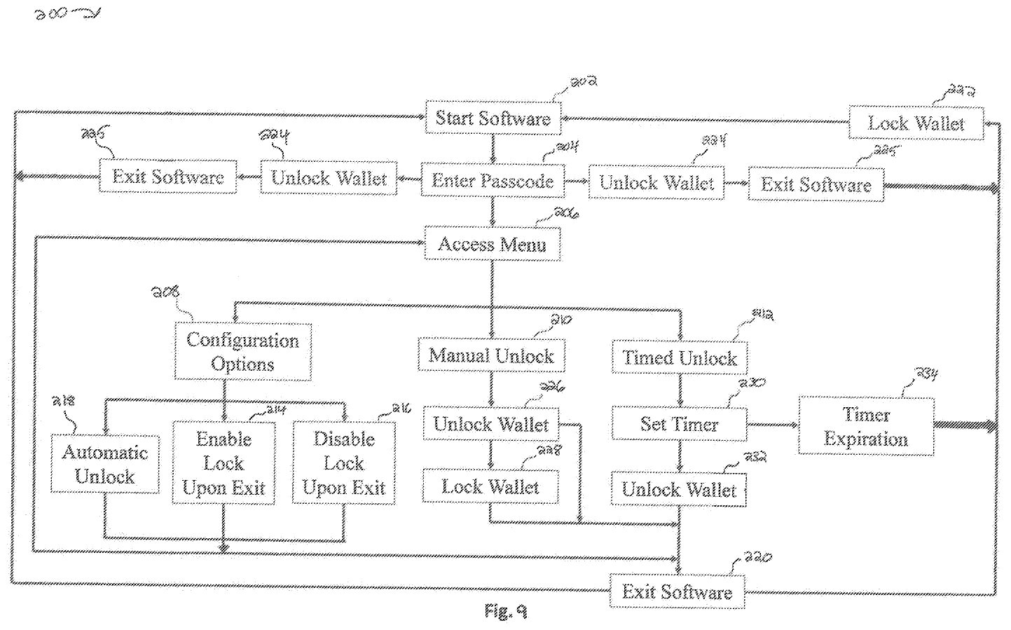

Referring now to FIG. 1, a perspective view of a mobile phone wallet (hereinafter “wallet”) 10 is shown. Wallet 10 may include a mobile phone portion 12 and a wallet portion 14. Mobile phone portion 12 may include a mobile phone 16 that is substantially rectangular in shape and may include, for instance, a face 18 having a display screen 20 and a speaker 22 and a bezel 24 having a a microphone (not pictured) and a plurality of buttons 26. In other embodiments, mobile phones having different sizes, shapes, and/or combinations of features may be included in the wallet. Wallet portion 14 of the present embodiment may be integrally formed with mobile phone portion 12 such that wallet 10 is an integrated unit. Put differently, mobile phone 16 of the present embodiment might be manufactured to include wallet portion 14, with wallet portion 14 forming an integral part of mobile phone 16 in such a manner that prevents separation of mobile phone portion 12 from wallet portion 14. In some embodiments, wallet portion 14 may be formed separately of mobile phone 16 and coupled thereto to form wallet 10. Referring now also to FIGS. 2-4, a first side view, a second side view, and a backside view of wallet 10 are illustrated. Wallet portion 14 includes a first section 30 and a second section 32, with second section 32 having a bottom side 28 that may include a camera 29. When wallet 10 is in a closed configuration, first section 30 may be in register with second section 32. Put differently, when first and second sections 30, 32 are arranged in a stacked configuration, each of a right side 34, a left side 36, a front side 38, and a back side 40 may be substantially planar and in alignment of the respective sections. The terms “right” and “left,” “front” and “back,” and the like are used herein in a relative sense, each in relation to each other, when viewing wallet 10 and should not necessarily be taken to mean that the device discussed herein has any particular orientation.

Referring now also to FIGS. 5 and 6, a cross-sectional view of wallet 10 showing a lock assembly 44 in a resting position is illustrated. Lock assembly 44 may include a lock bar 46 positioned within a right wall 48 of second section 32. Lock bar 46 may include a hook 50 structured to engage with a hook engaging surface 52 formed within a right wall 54 of first section 30. In some embodiments, lock bar 46 and hook engaging surface 52 may be in a different location; for example, lock bar 46 may be housed within first section 30, and/or may be housed within a front wall 58 or a back wall 60. Each of right wall 52 and right wall 54 may include an aperture 56 structured to receive hook 50. Lock bar 46 may be coupled to a front wall 58 and a back wall 60 by a plurality of springs 62 configured to put tension or compression on lock bar 46. Springs 62 and lock bar 46 may have a resting position in which hook 50 is in contact with lock engaging surface 52, and an activated position in which hook 50 may be in register with or otherwise positioned to pass through aperture 56. In FIG. 6, a cross-sectional view of lock assembly 44 in an activated position is shown. Wallet 10 may include an open button 42 structured to open wallet portion 14 between first and second sections 30, 32, with open button 42 structured to trigger the activated position of lock assembly 44. Open button 42 may be coupled with lock assembly 44 by conventional means such that pressing open button 42 moves lock bar 46 towards back wall 60 such that hook 50 is in register with aperture 56. In other embodiments, open button 42 may be a sliding button, a latch, a lever, a fingerprint scanner, or the like. Lock assembly 44 may also include a locking mechanism. The locking mechanism of the present embodiment may include a plunger 64 and a plunger opening 66, wherein plunger opening 66 may be positioned on or adjacent to lock bar 46 and is structured to receive plunger 64. Plunger 64 may prevent movement of lock bar 46 between front wall 58 and back wall 60 when received by plunger opening 66, thereby locking lock assembly 44 and securing wallet portion 14. Plunger opening 66 may be positioned on lock bar 46 such that when plunger 64 is received by plunger opening 66, lock assembly 44 may be in the resting position that may secure wallet portion 14, as seen in FIG. 5. In some embodiments, the locking mechanism may be structured to lock wallet 10 in a different manner. For example, the locking mechanism may include an electronically controlled magnetic lock, with the locking mechanism configured to use electric current to magnetize a magnetic lock to secure the wallet, and to cut off or otherwise restrict the flow of electric current to the magnetic lock to open the wallet. In still other embodiments, the locking mechanism may utilize any rotating or linear-actuated mechanical, magnetic, electronic, or other means for securing the wallet. Wallet 10 may operate on electrical power supplied by mobile phone 16, or via battery resident in wallet portion 14.

Referring now also to FIG. 7, wallet 10 is shown in an open configuration. First section 30 may include an inside surface 68 having a plurality of card slots 70 sized and shaped to receive cards 72 such as credit cards, business cards, reward cards, and the like. Inside surface 68 may also include an identification pocket 74 structured to receive an identification card such as a driver's license, a student identification card, a state identification card, or the like. Identification pocket 74 may include a substantially transparent window 76 configured such that a card in identification pocket 74 may be viewable. Second section 32 may have an inside surface 78 that includes a flap 80 structured to receive notes, such as currency 82. In other embodiments, inside surfaces 68, 78 may be configured differently and/or may include different structures to suit a wider range of applications. For example, inside surfaces 68, 78 may include pockets, keychains, hooks, loops, or the like, or may not include any structures at all. First section 30 may be pivotally coupled to second section 32 by a hinge 84 that may be concealed between first and second sections 30, 32 when wallet portion 14 is in a closed configuration (as can be seen in FIG. 3). It has been observed that a hinge or other connection may be a point of vulnerability for locking wallets. As such, the present disclosure contemplates wallets having a recessed or otherwise concealed hinge. Hinge 84 may be, for example, a butt hinge, a T-hinge, a strap hinge, a piano hinge, or any other type of hinge that may be concealable. A ribbon cable 86 structured to communicatively couple a processor or other electronic components of mobile phone 16 with electronic components housed in second section 32, such as camera 29 and/or lock mechanism 44, may extend between first and second portions 30, 32. Mobile phone 16 could communicate with lock mechanism 44 via any suitable wired or wireless, ultrasonic, electromagnetic, or other means. In some instances, entry of a user's passcode on mobile phone 16 (or face recognition) could trigger opening locking mechanism 44.

Referring now also to FIG. 8, a diagram of a mobile phone wallet system 100 is shown. Mobile phone 16 may be equipped with software 200, such as an app, configured to govern access to wallet portion 14 by providing a user interface capable of controlling lock assembly 44. System 100 may include a processor 102 structured to receive data from software 200 indicative of a command to lock or unlock wallet portion 14. System 100 may also include a controller 104 configured to receive a signal from processor 102 and structured to command a status change in lock assembly 44. For example, controller may command a solenoid 106 to energize to raise the plunger at block 108, thereby unlocking the wallet at block 110, or may command solenoid 106 to de-energize to lower the plunger at block 112, thereby locking the wallet at block 114. Dual solenoids might be used, with each selectively energized to move plunger 64 to a locking position or an unlocking position, and then de-energized to enable plunger 46 (or another movable lock element) to remain quiescent until actuated again. In still other embodiments, system 100 may include additional hardware communicatively coupled to processor 102 to, for instance, detect the contents of wallet portion 14.

Referring now also to FIG. 9, a flowchart illustrating operation of software 200 is shown. Upon first setup, software 200 may require the user to provide a passcode or other authenticating data, such as a fingerprint, a passphrase, facial recognition or the like. Once software 200 has been configured by the user, software 200 may govern access to wallet portion 14 by controlling lock assembly 44. A user may open software 200 at block 202, which may prompt the user for a passcode at block 204. Upon entering the correct passcode, the user may be taken to a menu at block 206, the menu having options to configure settings at block 208, to manually lock or unlock the wallet at block 210, or to set a timer at block 212. In an exemplary embodiment, the configuration settings may allow the user to choose whether to automatically lock the wallet when closing the software at block 214, or to disable the automatic locking feature at block 216. The configuration setting may also allow the user to turn on an automatic unlocking function at block 218. Once a user has entered the correct passcode at block 204, the automatic unlocking function may unlock the wallet at block 224 without further prompting. Upon exiting the software at block 225, the wallet may lock automatically at block 222 or remain unlocked depending on the settings the user selected in the configuration menu. The user may also select the manual locking and unlocking option at block 210, which may present a switch, slider, button, or the like that allows the user to unlock the wallet at block 226 or to lock the wallet at block 228. Upon exiting the software at block 220, the wallet may lock automatically at block 222 or may stay unlocked depending on the configuration settings chosen by the user at block 208. The user may also select the timer function at block 212. The user may then be prompted to set the timer at block 230, which may then unlock the wallet at block 232 without further prompting. Upon exiting the software at block 220, the software may be configured to keep the wallet unlocked until the timer expires at block 234, at which point the software will lock the wallet at block 222.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. It will be appreciated that certain features and/or properties of the present disclosure, such as relative dimensions or angles, may not be shown to scale. As noted above, the teachings set forth herein are applicable to a variety of different assemblies, devices, and/or systems having a variety of different structures than those specifically described herein. Other aspects, features and advantages will be apparent upon an examination of the attached drawings and appended claims. As used herein, the articles “a” and “an” are intended to include one or more items, and may be used interchangeably with “at least one.” Where only one item is intended, the term “one” or similar language is used. Also, as used herein, the terms “has,” “have,” “having,” or the like are intended to be open-ended terms.

What is claimed is:

1. A security device comprising:
a mobile phone portion including a mobile phone;
a wallet portion including a first section and a second section, each of the first section and the second section having an inside surface;
a hinge pivotally coupling the first section to the second section; and
a lock assembly communicatively coupled to the mobile phone and structured to lock the device.

2. A system for a securing a device comprising:
a security device including a mobile phone portion and a wallet portion, the wallet portion including a locking mechanism communicatively coupled to the mobile phone portion; and
software configured to provide a user interface for controlling the locking mechanism; and
the mobile phone portion including a processor structured to receive data from the software and a controller structured to receive a signal from the processor.
